(19) United States
(12) Patent Application Publication
(10) Pub. No.: US 2026/0113657 A1
(43) Pub. Date: Apr. 23, 2026

(54) NETWORK COVERAGE-BASED QUALITY OF SERVICE SCHEDULING

(71) Applicant: QUALCOMM Incorporated, San Diego, CA (US)

(72) Inventors: Shijun WU, San Diego, CA (US); Hong CHENG, Basking Ridge, NJ (US); Kapil GULATI, Belle Mead, NJ (US)

(21) Appl. No.: 18/920,725

(22) Filed: Oct. 18, 2024

(51) Int. Cl. H04W 28/02; H04L 12/14

(52) U.S. Cl. CPC H04W 28/0268; H04L 12/1407

(57) ABSTRACT

Methods, systems, and devices for wireless communication are described. Various aspects generally relate to network coverage-based quality of service (QoS) scheduling. Some aspects more specifically relate to one or more protocols according to which one or more network devices, entities, or functionalities may predict a level of network coverage at a user equipment (UE) across a future time window and generate a sequence of QoS values in accordance with the predicted network coverage levels. In some examples, an application function (AF) may obtain information indicative of the predicted network coverage levels and generate the sequence of QoS values in accordance with the predicted network coverage levels. The AF may transmit information indicative of the sequence of QoS values to a policy control function (PCF), which may provision at least one policy and charging control (PCC) rule in accordance with the sequence of QoS values.

### FIELD OF TECHNOLOGY

The following relates to wireless communication, including network coverage-based quality of service (QoS) scheduling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may be mobile and change location over time. Such a UE may experience different coverage scenarios over time resulting from the movement of the UE. For example, the UE may experience a first level of network coverage at a first location and a second level of network coverage at a second location. Differences between the network coverage at the first location and the second location may be due to one or more of various factors, including a proximity to a serving base station, a presence or absence of physical obstacles between the UE and the serving base station, or a UE orientation relative to the serving base station.

### SUMMARY

The systems, methods, and devices of this disclosure each have several innovative aspects, no single one of which is solely responsible for the desirable attributes disclosed herein.

A method for wireless communication by a core network entity is described. The method may include receiving first information indicative of a sequence of quality of service (QoS) values associated with a data flow, where the sequence of QoS values includes a first QoS value that corresponds to a first time segment within a time window and a second QoS value that corresponds to a second time segment within the time window and transmitting second information indicative of at least one policy and charging control (PCC) rule associated with the data flow, where the at least one PCC rule is in accordance with the sequence of QoS values associated with the data flow.

A core network entity for wireless communication is described. The core network entity may include one or more memories storing processor executable code, and one or more processors coupled with the one or more memories. The one or more processors may individually or collectively be operable to execute the code to cause the core network entity to receive first information indicative of a sequence of QoS values associated with a data flow, where the sequence of QoS values includes a first QoS value that corresponds to a first time segment within a time window and a second QoS value that corresponds to a second time segment within the time window and transmit second information indicative of at least one PCC rule associated with the data flow, where the at least one PCC rule is in accordance with the sequence of QoS values associated with the data flow.

Another core network entity for wireless communication is described. The core network entity may include means for receiving first information indicative of a sequence of QoS values associated with a data flow, where the sequence of QoS values includes a first QoS value that corresponds to a first time segment within a time window and a second QoS value that corresponds to a second time segment within the time window and means for transmitting second information indicative of at least one PCC rule associated with the data flow, where the at least one PCC rule is in accordance with the sequence of QoS values associated with the data flow.

A non-transitory computer-readable medium storing code for wireless communication is described. The code may include instructions executable by one or more processors to receive first information indicative of a sequence of QoS values associated with a data flow, where the sequence of QoS values includes a first QoS value that corresponds to a first time segment within a time window and a second QoS value that corresponds to a second time segment within the time window and transmit second information indicative of at least one PCC rule associated with the data flow, where the at least one PCC rule is in accordance with the sequence of QoS values associated with the data flow.

Some examples of the method, core network entities, and non-transitory computer-readable medium described herein may further include operations, features, means, or instructions for provisioning the at least one PCC rule in accordance with the sequence of QoS values associated with the data flow, where transmitting the second information may be in association with provisioning the at least one PCC rule.

In some examples of the method, core network entities, and non-transitory computer-readable medium described herein, the at least one PCC rule includes a single PCC rule and the single PCC rule includes a single QoS indicator value associated with the data flow; and a sequence of bitrate values associated with the data flow, the sequence of bitrate values including a first bitrate value corresponding to the first time segment within the time window and a second bitrate value corresponding to the second time segment within the time window.

In some examples of the method, core network entities, and non-transitory computer-readable medium described herein, the first bitrate value may be associated with the first QoS value and the second bitrate value may be associated with the second QoS value.

In some examples of the method, core network entities, and non-transitory computer-readable medium described herein, the at least one PCC rule includes a single PCC rule and the single PCC rule includes a sequence of QoS indicator values associated with the data flow, the sequence of QoS indicator values including a first QoS indicator value corresponding to the first time segment within the time window and a second QoS indicator value corresponding to the second time segment within the time window.

In some examples of the method, core network entities, and non-transitory computer-readable medium described herein, the first QoS indicator value may be associated with the first QoS value and the second QoS indicator value may be associated with the second QoS value.

In some examples of the method, core network entities, and non-transitory computer-readable medium described herein, the at least one PCC rule includes a single PCC rule and the single PCC rule includes a sequence of priority level values associated with the data flow, the sequence of priority level values including a first priority level value corresponding to the first time segment within the time window and a second priority level value corresponding to the second time segment within the time window.

In some examples of the method, core network entities, and non-transitory computer-readable medium described herein, the first priority level value may be associated with the first QoS value and the second priority level value may be associated with the second QoS value.

In some examples of the method, core network entities, and non-transitory computer-readable medium described herein, the at least one PCC rule includes a sequence of PCC rules and the sequence of PCC rules includes a first PCC rule corresponding to the first time segment within the time window and a second PCC rule corresponding to the second time segment within the time window.

In some examples of the method, core network entities, and non-transitory computer-readable medium described herein, the first PCC rule may be associated with the first QoS value and the second PCC rule may be associated with the second QoS value.

In some examples of the method, core network entities, and non-transitory computer-readable medium described herein, transmitting the second information indicative of the at least one PCC rule may include operations, features, means, or instructions for transmitting an indication of the first PCC rule at or prior to a beginning of the first time segment within the time window and transmitting an indication of the second PCC rule at or prior to a beginning of the second time segment within the time window.

In some examples of the method, core network entities, and non-transitory computer-readable medium described herein, the core network entity receives the first information indicative of the sequence of QoS values in association with at least a first communication metric associated with the data flow within the time window failing to satisfy a threshold, at least a second communication metric associated with the data flow within the time window satisfying the threshold, or both.

In some examples of the method, core network entities, and non-transitory computer-readable medium described herein, the first communication metric and the second communication metric may be predicted QoSs, predicted signal-to-interference-plus-noise ratios (SINRs), predicted spectral efficiencies, or predicted data rates associated with the data flow.

In some examples of the method, core network entities, and non-transitory computer-readable medium described herein, the core network entity includes a policy control function and the policy control function receives the first information from an application function and transmits the second information to a session management function.

In some examples of the method, core network entities, and non-transitory computer-readable medium described herein, the time window includes a set of multiple time segments and the set of multiple time segments may be of equal or different durations.

A method for wireless communication by a core network entity is described. The method may include receiving first information indicative of a sequence of communication metrics associated with a data flow, where the sequence of communication metrics includes a first communication metric associated with a first time segment within a time window and a second communication metric associated with a second time segment within the time window and transmitting second information indicative of a sequence of QoS values associated with the data flow, where the sequence of QoS values includes a first QoS value that corresponds to the first time segment within the time window and a second QoS value that corresponds to the second time segment within the time window.

A core network entity for wireless communication is described. The core network entity may include one or more memories storing processor executable code, and one or more processors coupled with the one or more memories. The one or more processors may individually or collectively be operable to execute the code to cause the core network entity to receive first information indicative of a sequence of communication metrics associated with a data flow, where the sequence of communication metrics includes a first communication metric associated with a first time segment within a time window and a second communication metric associated with a second time segment within the time window and transmit second information indicative of a sequence of QoS values associated with the data flow, where the sequence of QoS values includes a first QoS value that corresponds to the first time segment within the time window and a second QoS value that corresponds to the second time segment within the time window.

Another core network entity for wireless communication is described. The core network entity may include means for receiving first information indicative of a sequence of communication metrics associated with a data flow, where the sequence of communication metrics includes a first communication metric associated with a first time segment within a time window and a second communication metric associated with a second time segment within the time window and means for transmitting second information indicative of a sequence of QoS values associated with the data flow, where the sequence of QoS values includes a first QoS value that corresponds to the first time segment within the time window and a second QoS value that corresponds to the second time segment within the time window.

A non-transitory computer-readable medium storing code for wireless communication is described. The code may include instructions executable by one or more processors to receive first information indicative of a sequence of communication metrics associated with a data flow, where the sequence of communication metrics includes a first communication metric associated with a first time segment within a time window and a second communication metric associated with a second time segment within the time window and transmit second information indicative of a sequence of QoS values associated with the data flow, where the sequence of QoS values includes a first QoS value that corresponds to the first time segment within the time window and a second QoS value that corresponds to the second time segment within the time window.

Some examples of the method, core network entities, and non-transitory computer-readable medium described herein may further include operations, features, means, or instructions for transmitting a request associated with a network coverage prediction within the time window, where receiving the first information indicative of the sequence of communication metrics may be in association with transmitting the request.

Some examples of the method, core network entities, and non-transitory computer-readable medium described herein may further include operations, features, means, or instructions for transmitting the second information indicative of the sequence of QoS values may be in association with at least one communication metric of the sequence of communication metrics failing to satisfy a threshold.

Some examples of the method, core network entities, and non-transitory computer-readable medium described herein may further include operations, features, means, or instructions for transmitting the second information indicative of the sequence of QoS values may be in association with at least one communication metric of the sequence of communication metrics failing to satisfy a threshold and at least one other communication metric of the sequence of communication metrics satisfying the threshold.

In some examples of the method, core network entities, and non-transitory computer-readable medium described herein, the sequence of communication metrics includes a sequence of predicted communication metrics associated with the data flow.

In some examples of the method, core network entities, and non-transitory computer-readable medium described herein, the sequence of communication metrics includes a sequence of predicted QoSs, predicted SINRs, predicted spectral efficiencies, or predicted data rates associated with the data flow.

In some examples of the method, core network entities, and non-transitory computer-readable medium described herein, the core network entity includes an application function, the application function receives the first information from a network data analytics function (NWDAF), a cloud device, or a server device, and the application function transmits the second information to a policy control function.

In some examples of the method, core network entities, and non-transitory computer-readable medium described herein, the time window includes a set of multiple time segments and the set of multiple time segments may be of equal or different durations.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports network coverage-based quality of service (QoS) scheduling in accordance with one or more aspects of the present disclosure.

FIG. 2 shows an example of a network coverage timeline that supports network coverage-based QoS scheduling in accordance with one or more aspects of the present disclosure.

FIG. 3 shows an example of a network diagram that supports network coverage-based QoS scheduling in accordance with one or more aspects of the present disclosure.

FIG. 4 shows an example of a process flow that supports network coverage-based QoS scheduling in accordance with one or more aspects of the present disclosure.

FIGS. 5 and 6 show block diagrams of devices that support network coverage-based QoS scheduling in accordance with one or more aspects of the present disclosure.

FIG. 7 shows a block diagram of a communications manager that supports network coverage-based QoS scheduling in accordance with one or more aspects of the present disclosure.

FIG. 8 shows a diagram of a system including a device that supports network coverage-based QoS scheduling in accordance with one or more aspects of the present disclosure.

FIGS. 9-12 show flowcharts illustrating methods that support network coverage-based QoS scheduling in accordance with one or more aspects of the present disclosure.

### DETAILED DESCRIPTION

In some wireless communications systems, a user equipment (UE) may be mobile and change location over time. For example, the UE (e.g., a vehicle or a moving handheld device) may move from an origin to a destination along a route. In some cases, the UE may experience different coverage scenarios over time resulting from the movement of the UE. For example, the UE may experience a first (e.g., relatively better) level of network coverage at a first location along the route and a second (e.g., relatively worse) level of network coverage at a second location along the route.

Differences between the network coverage at the first location and the second location may be due to one or more of various factors, including a proximity to a serving base station, a presence or absence of physical obstacles between the UE and the serving base station, or a UE orientation relative to the serving base station, among other factors.

Such a variation in network coverage may result in intermittent, occasional, or frequent uplink data transfer failures (of real-time vehicle sensor data or navigation information, among other examples) or downlink data transfer failures (of remote operation commands for a vehicle or video packets, among other examples), which may cause poor performance of one or more applications at the UE. Some systems may attempt to resolve such a variation in network coverage by requesting alternative quality of service (QoS) profiles or targets when different network coverages are measured or experienced. Such systems may be reactive and have time periods within which a current QoS profile provides insufficient performance (e.g., before a new QoS profile is requested based on the insufficient performance). Thus, some systems may benefit from additional configurational capabilities to maintain a sufficient application performance across varying network coverage levels over time.

Various aspects generally relate to network coverage-based QoS scheduling. Some aspects more specifically relate to one or more signaling-or configuration-based protocols according to which one or more network devices, entities, or functionalities may predict a level of network coverage at a UE across a future time window and generate (e.g., select, create, schedule, or otherwise determine) a sequence of QoS values in accordance with the predicted network coverage levels. The sequence of QoS values may be associated with a specific data flow between the UE and an application server (AS). In some examples, an application function (AF) may obtain information indicative of the predicted network coverage levels and generate the sequence of QoS values in accordance with the predicted network coverage levels. The sequence of QoS values may be a time domain series of QoS values, each QoS value corresponding to a respective time segment within the time window. The AF may transmit (e.g., provide, output, or otherwise convey) information indicative of the sequence of QoS values to a policy control function (PCF), which may provision (e.g., create, generate, select, or otherwise determine) at least one policy and charging control (PCC) rule in accordance with the indicated sequence of QoS values. The PCC rule(s) may be associated with a sequence (e.g., a time domain series) of values, parameters, characteristics, rules, or any combination thereof in accordance with the sequence of QoS values. The PCF may provide the PCC rule(s) to a session management function (SMF), which may instruct a user plane function (UPF) to enforce an authorized QoS (or multiple authorized QoSs over time) associated with the PCC rule(s).

Particular aspects of the subject matter of the present disclosure can be implemented to realize one or more of the following advantages. For example, by providing a sequence of QoS values to a PCF in accordance with a time-varying network coverage prediction for a UE, the PCF may provision one or more PCC rules such that an authorized QoS associated with a data flow to the UE changes over time (within a time window associated with the sequence of QoS values) in accordance with the time-varying network coverage prediction. An authorized QoS that changes over time in accordance with a time-varying network coverage prediction may result in at least some data transfers being prioritized within time segments associated with relatively better network coverage, which may facilitate a consistent and sufficient overall performance across a time window. Such a consistent and sufficient overall performance may provide improved service to the UE, as the network may compensate for predicted lower data rates at some times by increasing a data rate at other (e.g., earlier) times to satisfy one or more targets or expectations associated with a data flow to or from the UE. Further, in accordance with supporting a sequence of QoS values and one or more associated PCC rules, the network may provide greater system flexibility to adapt to various network coverage scenarios that a UE may experience, higher overall data rates, higher reliability, improved application performance, and a greater user experience, among other benefits.

Aspects of the disclosure are initially described in the context of wireless communications systems. Additionally, aspects of the disclosure are further illustrated by and described with reference to a network coverage timeline, a network diagram, and a process flow. Aspects of the disclosure are further illustrated by and described with reference to apparatus diagrams, system diagrams, and flowcharts that relate to network coverage-based QoS scheduling.

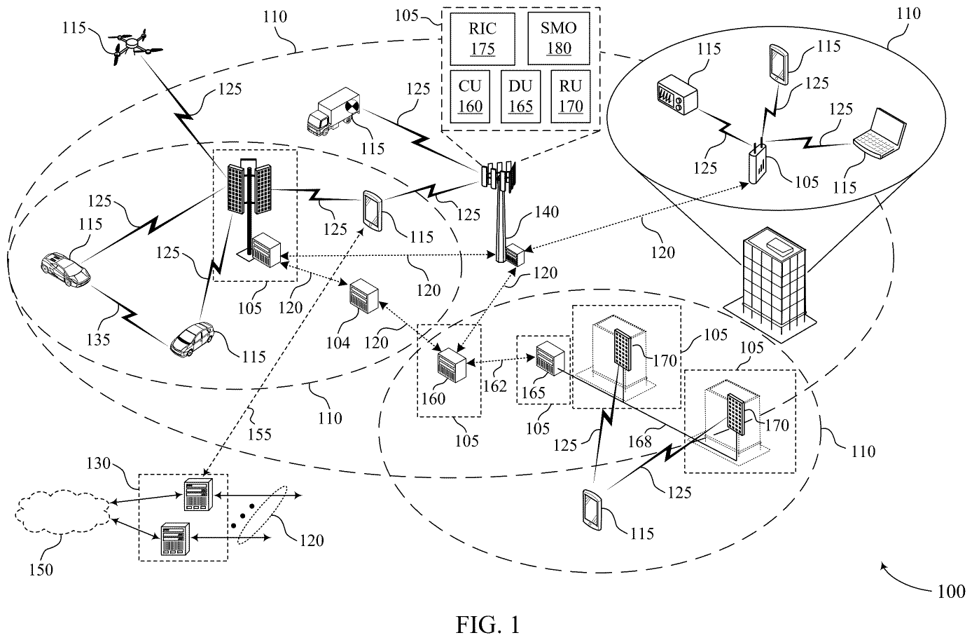

FIG. 1 shows an example of a wireless communications system 100 that supports network coverage-based QoS scheduling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support network coverage-based QoS scheduling as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a UPF). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions.

The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

For some verticals, such as vehicles, connectivity may become increasingly impactful to operation. For example, a vehicle may include an infotainment system (e.g., an in-cabin infotainment system) associated with data streaming and the vehicle may be wirelessly connected to the network to support the data streaming for the infotainment system. By way of further example, a vehicle may support autonomous driving or navigation functionalities, which may involve downloading a real-time (high-definition) map from a cloud/server or uploading sensor data or vehicle status data to the network (e.g., to a network entity 105), or both. In some countries or geographic locations, autonomous driving vehicles may be expected (in accordance with a regulation) to be wirelessly connected to the network (e.g., via a wireless connection with a network entity 105).

A UE 115 may experience different levels of network coverage depending on, for example, a location (e.g., a geographic location or position) of the UE 115, a presence or absence of one or more obstacles between the UE 115 and a network entity 105, or an orientation of the UE 115 with respect to the network entity 105, among other examples. For example, a mobile UE 115 (e.g., a vehicle) may experience different levels of network coverage (e.g., network connectivity) over time in accordance with a movement of the UE 115 between different locations, with some locations associated with relatively better network coverage and some other locations associated with relatively worse network coverage. In other words, network coverage may not be uniform or available everywhere. For example, some roads may not be covered by a network coverage, due to one or more of various reasons. Additionally, or alternatively, for the roads with network coverage, the coverage may not be uniform. For example, a road may have varying network coverage quality and varying user experience.

In some scenarios, an unavailability or a variability of network coverage may adversely impact automotive connectivity or user experience. In other words, a variation in network coverage/communication performance may cause problems for some automotive connectivity applications, among other applications associated with wireless connections and varying network connectivity. For example, for non-live in-cabin streaming (e.g., YouTube or Netflix, among other examples), degraded network coverage may lead to degraded video quality (e.g., when an adaptive bit rate codec is employed) or an interruption to the streaming. By way of further example, for tele-operated driving or remote driving, degraded network coverage may result in a failure of an uplink data transfer (e.g., real-time vehicle sensor data for a remote control purpose) or a failure of remote operation of the vehicle, which may reduce user safety and increase the likelihood of an accident.

To improve efficiency and performance, some UEs 115 may leverage prediction related to cellular connections (e.g., cellular connectivity). For cellular communication, prediction may be more relevant for data-driven networks. Cellular prediction may include small granularity prediction or large granularity prediction, or both. Small granularity prediction may include predicting a channel quality indicator (CQI) or a modulation and coding scheme (MCS) for a next several moments (e.g., 20 milliseconds) in accordance with (e.g., based on) measurements performed by a UE 115 in a past time window (e.g., a previous amount of time, such as 100 milliseconds). Large granularity prediction may include predicting network coverage for a (vehicle) route in accordance with (e.g., based on) historical data collected for the same or a similar route by the same UE 115 or by one or more different UEs 115. Metrics associated with or that define network coverage may include a signal-to-interference-plus-noise ratio (SINR) or a data rate, among other examples.

In some examples, prediction may be based on or otherwise associated with data collected in the network or system (e.g., in a 5G core (5GC)). For example, in some systems, a network data analytics function (NWDAF) on one or more wireless communication devices may collect data from data producers (e.g., from one or more 5GC entities or from one or more UEs 115, or any combination thereof). A network entity 105 or a UE 115 may use data collected by the NWDAF for prediction purposes. Additionally, or alternatively, prediction may be based on or otherwise associated with data collected by a UE 115 or an application. For example, UEs 115 (e.g., vehicles) equipped with one or more specific chipsets may collect modem data (which may include information indicative of a reference signal receive power (RSRP), an SINR, a user experienced data rate, among other examples). A UE 115 may store geo-tagged data (which may include data associated with a specific geographic location) locally or may crowdsource the geo-tagged data to the cloud (e.g., one or more memories located at a physically separate device or location, such as in accordance with a car-to-cloud service).

Depending on a system model, prediction using the collected data may be performed at a UE 115 (e.g., a vehicle), at the cloud, or at one or more other network devices, entities, or functionalities. As described herein, examples of prediction (e.g., predicted metrics) may include RSRP, SINR, spectral efficiency, or a user experienced data rate, among other examples, at a specific location. In an automotive use case, an autonomous vehicle's route (from a current location of the vehicle to a destination of the vehicle) may be obtained from navigation (e.g., a navigation application) and, for this obtained route (e.g., sampled location along the route), network coverage (e.g., an RSRP, an SINR, a channel state information (CSI), an MCS, a latency, or a user experienced data rate, among other examples) may be predicted based on or otherwise in accordance with historical data collected by one or more vehicles (data collected by the vehicle actively traveling the route or crowdsourced data from other vehicles, or any combination thereof) or real-time data collected by the network, or both.

In examples in which a UE 115 supports such prediction, and if performance degradation is predicted, for non-real-time traffic (e.g., buffered/non-live streaming, high definition map downloading for autonomous driving), more data may be pre-downloaded and buffered at the UE 115 when the UE 115 is in good coverage, which may support a consistent user experience. For real-time traffic (e.g., an uplink sensor data transfer), the priority of the traffic may be elevated (e.g., increased) to secure (e.g., obtain or be allocated) more network resources for the traffic (such as to meet or satisfy “guaranteed” (e.g., expected) service requirements associated with the real-time traffic).

Accordingly, in some implementations, one or more network devices, entities, or functionalities may support network protocols to enable such a pre-downloading of data or such an elevation of a traffic priority in accordance with a predicted network coverage. Some aspects more specifically relate to QoS scheduling based on or otherwise in accordance with prediction. Such aspects may include, for example, network protocols for utilizing prediction to enable or support QoS scheduling. For example, one or more network devices, entities, or functionalities may support and leverage a sequence of QoS values associated with one or more applications. Such a sequence of QoS values may be a time domain series of QoS values, such that a first QoS value of the sequence of QoS values may correspond to a first time segment within the time window and a second QoS value of the sequence of QoS values may correspond to a second time segment within the time window.

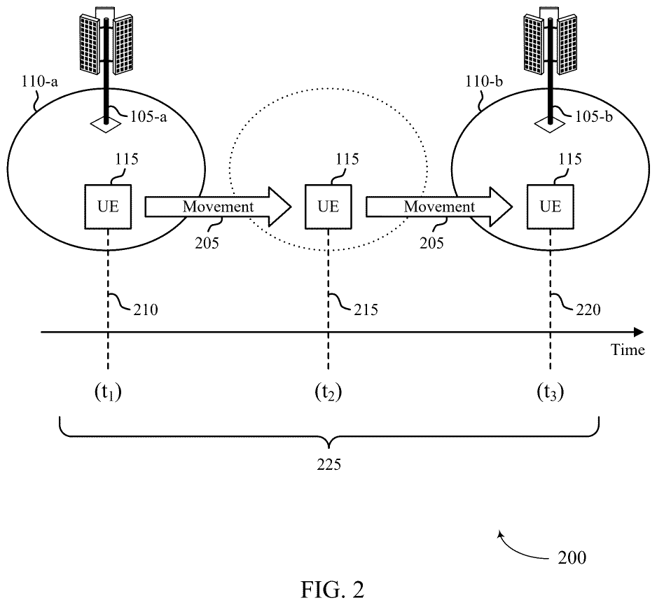

FIG. 2 shows an example of a network coverage timeline 200 that supports network coverage-based QoS scheduling in accordance with one or more aspects of the present disclosure. The network coverage timeline 200 illustrates a movement 205 of a UE 115 in physical space, with some geographic areas, locations, or positions being associated with relatively better network coverage and some other geographic areas, locations, or positions being associated with relatively worse network coverage. The UE 115 illustrated in the example of the network coverage timeline 200 may be any type of mobile UE, such as a wirelessly connected vehicle or a handheld device carried by a passenger within a moving vehicle, among other examples of devices for which larger-granularity (e.g., network coverage) prediction is available.

As illustrated by the network coverage timeline 200, the UE 115 may move from a coverage area 110-a of a network entity 105-a to a coverage area 110-b of a network entity 105-b. In some examples, the network entity 105-a and the network entity 105-b may be two different network entities 105. In such examples, the UE 115 may move away from a first network entity 105 and toward another network entity 105. In some other examples, the network entity 105-a and the network entity 105-b may be a same network entity 105. In such examples, the UE 115 may move away from a network entity 105 and return toward the network entity 105.

At a first time 210 (e.g., t₁), the UE 115 may be at a first location within a coverage area 110-a of a network entity 105-a. The first location may be associated with a first level of network coverage (e.g., a first amount or quality of network coverage), which may be relatively better network coverage as compared to some other locations. At a second time 215 (e.g., t₂), the UE 115 may be at a second location that is outside of or at the edge of the coverage area 110-a of the network entity 105-a. The second location may be associated with a second level of network coverage (e.g., a second amount or quality of network coverage), which may be relatively worse network coverage as compared to some other locations. At a third time 220 (e.g., t₃), the UE 115 may be at a third location within a coverage area 110-b of a network entity 105-b. The third location may be associated with a third level of network coverage (e.g., a third amount or quality of network coverage), which may be relatively better network coverage as compared to some other locations. For example, the second location may be associated with relatively worse network coverage as compared to the first location and the second location.

The first time 210, the second time 215, and the third time 220 may be times within a time window 225. In some aspects, the first time 210, the second time 215, and the third time 220 may be associated with, within, or correspond to respective time segments within the time window 225. For example, a first time segment may include the first time 210, a second time segment may include the second time 215, and a third time segment may include the third time 220. A time segment may correspond to an instance of time or some duration of time. Different time segments may have a same duration or may have different durations. For example, each of the first time segment, the second time segment, and the third time segment may have a same duration, or at least one of the time segments may have a different duration as compared to the other time segments within the time window 225.

In some implementations, one or more network devices, entities, or functionalities may obtain information indicative of or predict the movement 205 of the UE 115. The one or more network devices, entities, or functionalities may obtain information indicative of or predict the movement 205 in accordance with a navigation application running at the UE 115, in accordance with a known, indicated, or predicted destination of the UE 115, or in accordance with routes taken by other UEs 115 (with same or similar final or intermediate destinations) within a recent time period, among other examples. The one or more network devices, entities, or functionalities may likewise predict that the UE 115 may have relatively better network coverage at the first time 210, relatively worse network coverage at the second time 215, and relatively better network coverage at the third time 220 in accordance with the known, indicated, or predicted movement 205 of the UE 115.

The one or more network devices, entities, or functionalities may predict the network coverage of the UE 115 over time in accordance with previous measurements of other UEs 115 along a same or similar route or in accordance with various other factors. For example, the one or more network devices, entities, or functionalities may predict the network coverage of the UE 115 at each of one or multiple discrete time segments in accordance with one or more factors, such as a speed of the UE 115. In such examples, the one or more network devices, entities, or functionalities may determine a coverage level at each of various geographic locations (e.g., in accordance with various factors, such as base station locations or previous UE measurements) and may predict the coverage for the UE 115 at each of various times in accordance with predicting when the UE 115 will be within or near one or more of such various locations (with such a prediction being based on, for example, the movement 205 and the speed of the UE 115). The one or more network devices, entities, or functionalities may determine or predict the speed of the UE 115, which may be approximately constant or variable over time, in accordance with a navigation application running at the UE 115, in accordance with (live or historical) data obtained from the UE 115, or in accordance with speeds used by other UEs 115 on a same or similar route within a recent time period, among other examples.

In examples in which the UE 115 is a wirelessly connected vehicle, the UE 115 may continuously or periodically downlink map tiles for upcoming road segments as part of a high definition map downloading. In such examples, and in accordance with the movement 205 of the UE 115, network coverage may be relatively poor at some road segments (e.g., at the second location), such that the available network coverage may be unable to fulfill real-time downloading of the upcoming road segments. Thus, in implementations in which the one or more network devices, entities, or functionalities are able to predict the poor coverage road segments, the one or more network devices, entities, or functionalities may trigger, cause, or facilitate a downloading of map tiles for road segments with poor coverage to be pushed forward (in the time domain). In other words, the one or more network devices, entities, or functionalities may trigger, cause, or facilitate a pre-downloading of map tiles when the UE 115 is in a relatively good coverage area (to compensate for a potential interruption or worsening of network coverage in a near future).

To realize, enable, or facilitate such a pre-downloading of data (e.g., map tiles) to the UE 115 in accordance with predicted coverage levels for the UE 115 over time, the one or more network devices, entities, or functionalities may support prediction-based QoS scheduling, with a QoS schedule indicating or otherwise pertaining to time sequenced QoS levels. In some implementations, an interface between a PCF and an AF (e.g., a PCF to AF response) may support one or more signaling-based protocols associated with such time sequenced QoS levels, such that a layered QoS level may be requested or provided for a service session at or to the UE 115. The interface between the PCF and the AF may be referred to as an N5 or an Npcf interface, among other examples. The AF may provide a scheduling of QoS levels to the PCF based on a sequenced request, with such a sequenced request being a request for different QoS levels with some time sequence (e.g., a series of QoS values or levels along a timeline).

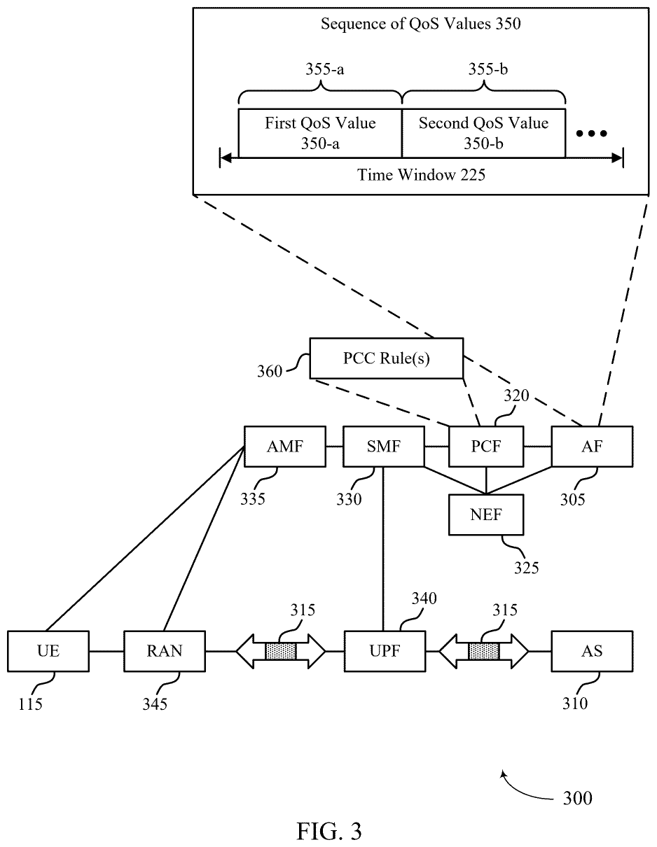

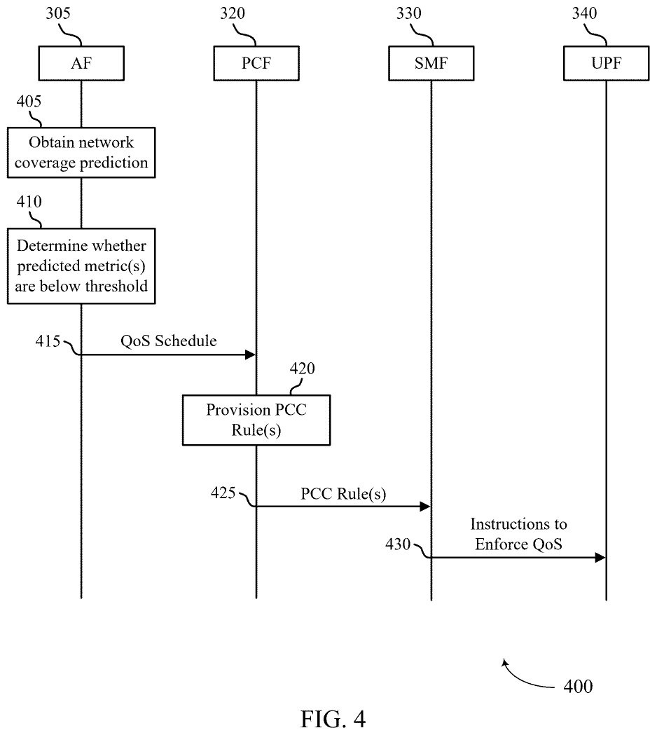

Further, an interface between the PCF and an SMF may also support one or more signaling-based protocols associated with time sequenced QoS levels. In some examples, the PCF may maintain (e.g., store) the time sequenced QoS levels and instruct changes to one or more session management PCC rules in accordance with the time sequenced QoS levels. Additionally, or alternatively, the PCF may provide one or more time sequenced session management PCC rules to the SMF and the SMF may execute the time sequenced session management PCC rule(s). Additional details relating to such signaling-based protocols involving two or more of the AF, the PCF, and the SMF are illustrated and described herein, including by and with reference to FIGS. 3 and 4.

FIG. 3 shows an example of a network diagram 300 that supports network coverage-based QoS scheduling in accordance with one or more aspects of the present disclosure. For example, the network diagram 300 illustrates one or more network devices, entities, or functionalities that may support prediction-based QoS scheduling. The various network devices, entities, or functionalities illustrated by the network diagram 300 include an AF 305, an AS 310, a PCF 320, a network exposure function (NEF) 325, an SMF 330, an access and mobility function (AMF) 335, a UPF 340, a RAN 345 (which may be an example of or understood as being located at a base station 140), and a UE 115. The UE 115, which may be an example of corresponding devices as illustrated and described herein, may communicate (e.g., transmit or receive) packets associated with a data flow 315 with the AS 310 (via the UPF 340 and the RAN 345).

In some aspects, one or more network devices, entities, or functionalities may support QoS provisioning to meet (e.g., satisfy) various communication constraints, targets, or expectations. A QoS mechanism may enable the provision of different priorities to different applications, users, or data flows, or to set or achieve a specific level of performance to a data flow. In some systems, such as 5G NR systems, QoS may be enforced at the QoS flow level. For example, each set of QoS flow packets may be classified and marked using a QoS flow identifier (QFI). QoS flows may be mapped in an access network to data radio bearers (DRBs) for transmission.

In some QoS frameworks, the AF 305 may determine QoS targets, constraints, or expectations for an application and may provide QoS reference or parameters to the PCF 320. The PCF 320 may provision a PCC rule 360 (or activate a pre-defined PCC rule 360) and may send the PCC rule 360 to the SMF 330. A PCC rule 360 may include QoS related information. The SMF 330 may determine an authorized QoS of a QoS flow using one or more PCC rules 360 associated with the QoS flow. A user plane, such as the UPF 340, may perform a two-step mapping from an IP flow to a QoS flow. A first step may be associated with the NAS and a second step may be associated with the access stratum. In the first step, NAS level packet filters (in the UE 115 or in the core network) may associate (uplink or downlink) packets with QoS flows (IP flow to QoS flow) and, in the second step, access stratum level mapping rules (in the UE 115 or the RAN 345) may associate (uplink or downlink) QoS flows with DRBs (QoS flow to DRB). In some aspects, one or more network devices, entities, or functionalities may support different QoS targets, constraints, or expectations for different traffic types such that, for example, QoS parameters may be maintained by the system during a lifetime of one or more protocol data unit (PDU) sessions.

To support prediction-based QoS scheduling, the AF 305 may obtain a network coverage prediction for a future time, such as for a future time window (e.g., the time window 225). In some examples, the AF 305 may query an NWDAF for the prediction associated with the network coverage. Additionally, or alternatively, the AF 305 may obtain the prediction from another source, such as from a proprietary (e.g., manufacturer or operator specific) cloud or server. The network coverage prediction may be based on or otherwise associated with one or more predicted QoS values, one or more predicted SINR values, one or more predicted spectral efficiency values, or one or more predicted data rate values, among other examples. For example, the prediction may be (or may be associated with) a predicted user data rate for a specific traffic priority, at each segment of the time window 225 (e.g., a ‘piecewise’ data rate prediction in the future or upcoming time window 225).

The AF 305 may obtain information indicative of a first predicted communication metric (e.g., a first predicted data rate) within a first time segment 355-a of the time window 225 and a second predicted communication metric (e.g., a second predicted data rate) within a second time segment 355-b of the time window 225. The time window 225 may include any quantity of time segments, with the time segments within the time window 225 being associated with equal durations (e.g., a same quantity of milliseconds, time units (TUs), symbols, or slots, among other examples) or variable (e.g., different) durations (e.g., a different quantities of milliseconds, TUs, symbols, or slots, among other examples).

The AF 305 may determine whether the predicted network coverage (e.g., one or more of the predicted metrics) is below a threshold network coverage. For example, within the time window 225, a predicted metric may not be uniform and instead may be relatively better at some times and relatively worse at some other times. By way of example, a predicted user data rate may be [14, 15, 15, 12, 10, 10, 7, 2, 1, 0, 2, 6] megabits per second (Mbps) for a time window 225 of 1 minute (such that each predicted user data rate value may correspond to a 5 second segment of the 1 minute time window 225). If a data rate threshold is 5 Mbps for a given application (e.g., high definition streaming), the AF 305 may determine that there are some time instances or segments at or within which the predicted data rate is below the threshold and that there are some other (earlier) time instances or segments at or within which the predicted data rate is greater than or equal to the threshold.

In such scenarios in which the AF 305 determines that a predicted communication metric fails to satisfy a threshold at some times and satisfies the threshold at some other (earlier) times within the time window 225, the AF 305 may determine to employ, utilize, activate, or trigger QoS scheduling (e.g., prediction-based QoS scheduling). Additionally, or alternatively, the AF 305 may determine to employ, utilize, activate, or trigger QoS scheduling in accordance with an application running at the UE 115 supporting or requesting QoS scheduling. In accordance with the QoS scheduling, the AF 305 may enable the network to scale up a data rate in time instances or segments with a better predicted data rate to pre-buffer data. The AF 305 may enable the network to scale up a data rate in time instances or segments by generating, selecting, or otherwise determining a sequence of QoS values 350. The sequence of QoS values 350 may include a first QoS value 350-a that corresponds to the first time segment 355-a within the time window 225, a second QoS value 350-b that corresponds to the second time segment 355-b within the time window 225, and so on. The first QoS value 350-a may be the same as or different from the second QoS value 350-b, with each being separately indicated or defined for respective time segments within the time window 225.

The AF 305 may indicate (e.g., output or transmit information indicative of) the sequence of QoS values 350 associated with prediction-based QoS scheduling to the PCF 320. For example, the AF 305 may send a message (e.g., a single message or multiple messages within a threshold duration) indicative of the sequence of QoS values 350. The message may indicate, implicitly or via one or more fields or bits, that each QoS value of the sequence of QoS values 350 corresponds to a respective time segment within the time window 225. In other words, for a service data flow (e.g., the data flow 315), the AF 305 may indicate QoS values (e.g., QoS targets, constraints, or expectations) as a piecewise function. The AF 305 may indicate two or more QoS values by indicating a vector for each segment or time instance in the time window 225.

The PCF 320 may receive the sequence of QoS values 350 from the AF 305 and may provision (e.g., generate, select, or otherwise determine) one or more PCC rules 360 based on the sequence of QoS values 350. In some aspects, the PCF 320 may provision the one or more PCC rules 360 based on both the sequence of QoS values 350 and a subscription associated with the UE 115. For example, an average of the one or more PCC rules 360 may satisfy or otherwise be in accordance with the subscription associated with the UE 115. By way of further example, the subscription associated with the UE 115 may set a higher bound for the one or more PCC rules 360, such that the one or more PCC rules 360 do not prioritize a data flow to the UE greater than allowed or indicated by the subscription associated with the UE 115.

In some examples, the PCF 320 may provision a single PCC rule 360 and the PCC rule 360 may include (e.g., indicate or define) a single QoS indicator value (e.g., a 5G QoS indicator (5QI) value or any other type of QoS indicator value) associated with the data flow 315 and may include (e.g., indicate or define) multiple bitrate values for the time window 225. In such examples, the single QoS indicator value may correspond to an entirety of the time window 225 and each bitrate value of the multiple bitrate values may correspond to a respective time segment within the time window 225. For example, the multiple bitrate values may be multiple downlink expected or targeted (e.g., “guaranteed”) bitrate values with each corresponding to a portion of the time window 225. By way of further example, a first bitrate value of the multiple bitrate values may correspond to the first time segment 355-a, a second bitrate value of the multiple bitrate values may correspond to the second time segment 355-b, and so on.

The first bitrate value may be based on or otherwise associated with the first QoS value 350-a and the second bitrate value may be based on or otherwise associated with the second QoS value 350-b.

In some other examples, the PCF 320 may provision a single PCC rule 360 and the PCC rule 360 may include multiple QoS indicator values (e.g., multiple 5QI values or any other type of QoS indicator values) associated with the data flow 315, each corresponding to a respective time segment of the time window 225. A QoS indicator value may be a scalar value that corresponds to a set of QoS parameters or characteristics associated with a specific QoS flow. Such parameters or characteristics may include a priority level; an expected/targeted bitrate or an upper limit bitrate; limits on latency, jitter, or error rate; scheduling weights; admission thresholds; queue management threshold; or a link layer protocol configuration. Thus, of the multiple QoS indicator values included within the PCC rule 360 associated with the data flow 315, at least a priority level in at least one of the QoS indicator values may be different from a priority level in another QoS indicator value included within the PCC rule 360.

For example, the multiple QoS indicator values may include a first QoS indicator value that corresponds to the first time segment 355-a and a second QoS indicator value that corresponds to the second time segment 355-b, with the first QoS indicator value associated with (e.g., including or indicating) a first priority level and the second QoS indicator value associated with (e.g., including or indicating) a second priority level different from the first priority level. The first QoS indicator value may be based on or otherwise associated with the first QoS value 350-a and the second QoS indicator value may be based on or otherwise associated with the second QoS value 350-b. Other parameters or characteristics indicated by the multiple QoS indicator values may be the same across all the QoS indicator values within the PCC rule 360 or may be at least partially different between at least two QoS indicator values.

In some other examples, the PCF 320 may provision a single PCC rule 360 and the PCC rule 360 may include multiple priority level values associated with the data flow 315, each corresponding to a respective time segment of the time window 225. In such examples, at least two of the priority level values may be different from each other. For example, the multiple priority level values may include a first priority level value that corresponds to the first time segment 355-a and a second priority level value that corresponds to the second time segment 355-b, with the first priority level value being different from the second priority level value. The first priority level may be based on or otherwise associated with the first QoS value 350-a and the second priority level may be based on or otherwise associated with the second QoS value 350-b.

In some other examples, the PCF 320 may provision multiple PCC rules 360 associated with the data flow 315, each corresponding to a respective time segment of the time window 225. For example, the multiple PCC rules 360 may include a first PCC rule 360 that corresponds to the first time segment 355-a, a second PCC rule 360 that corresponds to the second time segment 355-b, and so on. The first PCC rule 360 may be based on or otherwise associated with the first QoS value 350-a and the second PCC rule 360 may be based on or otherwise associated with the second QoS value 350-b.

In association with provisioning at least one PCC rule 360 in accordance with the sequence of QoS values 350 associated with the data flow 315, the PCF 320 may provide (e.g., output or transmit information indicative of) the at least one PCC rule 360 to the SMF 330. In some examples, the PCF may implement the prediction-based QoS scheduling and update the PCC rule 360 at the SMF 330 when a different bitrate, QoS indicator value, or priority level is expected (in accordance with the PCC rule(s) 360 provisioned or generated by the PCF 320). For example, the PCF 320 may provide a first PCC rule 360 (as a partial update relative to a current/previous PCC rule 360 or as a new PCC rule 360) to the SMF 330 at or prior to a beginning of the first time segment 355-a and may provide a second PCC rule 360 (as a partial update relative to the first PCC rule 360 or as a new PCC rule 360) to the SMF 330 at or prior to a beginning of the second time segment 355-b. In such examples, the SMF 330 may rely on PCC rule updates from the PCF 320 to facilitate the prediction-based QoS scheduling.

In some other examples, the PCF 320 may provide a PCC rule 360 to the SMF 330 that includes one or more of multiple bitrate values, multiple QoS indicator values, or multiple priority level values. In such examples, the SMF 330 may implement the prediction-based QoS scheduling by enforcing QoS based on the single PCC rule 360 that includes one or more of multiple bitrate values, multiple QoS indicator values, or multiple priority level values. Further, in such examples in which the SMF 330 receives the PCC rule 360 that includes one or more of multiple bitrate values, multiple QoS indicator values, or multiple priority level values, the SMF 330 may instruct the UPF 340 to enforce an authorized QoS in accordance with the PCC rule 360. The authorized QoS may change across time segments within the time window 225 in accordance with the PCC rule 360 including (e.g., indicating, defining, or specifying) one or more of multiple bitrate values, multiple QoS indicator values, or multiple priority level values. For example, the SMF 330 may enforce a first authorized QoS at the UPF 340 within the first time segment 355-a, may enforce a second authorized QoS at the UPF 340 within the second time segment 355-b, and so on. The RAN 345 may provide (e.g., transmit or output for transmission) packets associated with the data flow 315 in accordance with the authorized QoS enforced at the UPF 340.

Further, although some aspects are illustrated and described as being performed by one or more specific network devices, entities, or functionalities of the network diagram 300, any one or more network devices, entities, or functionalities may individually or collectively perform the described aspects without exceeding the scope of the present disclosure. For example, and more generally, a first network device, entity, or functionality may determine the sequence of QoS values 350 in accordance with a network coverage prediction and may provide the sequence of QoS values 350 to a second network device, entity, or functionality. The second network device, entity, or functionality may provision at least one PCC rule 360 in accordance with the sequence of QoS values 350 and provide the at least one PCC rule 360 to a third network device, entity, or functionality. The third network device, entity, or functionality may enforce the at least one PCC rule 360 such that packets associated with the data flow 315 are communicated between the UE 115 and the RAN 345 in accordance with the sequence of QoS values 350. Such first, second, and third network devices, entities, or functionalities may be located on a same physical device or may be at least partially distributed across different physical devices. Additionally, or alternatively, such first, second, and third network devices, entities, or functionalities may be different network devices, entities, or functionalities, or two or more of such first, second, and third network devices, entities, or functionalities may be a same network device, entity, or functionality.

Further, although some aspects are illustrated and described as a sequence of values, parameters, or rules in time, one or more network devices, entities, or functionalities may additionally, or alternatively, support one or more sequences of values, parameters, or rules in geographic or physical space. For example, in addition to or instead of each QoS value of a sequence of QoS values corresponding to a respective time segment within a time window, each QoS value of a sequence of QoS values may correspond to a respective geographic location or position. In such examples, a first QoS value may correspond to a first geographic location or position and a second QoS value may corresponds to a second geographic location or position. One or more network devices, entities, or functionalities may use such spatially-defined QoS values to provision one or more PCC rules 360 associated with a sequence of values, characteristics, or parameters, with each value/characteristic/parameter of the sequence of values, characteristics, or parameters corresponding to a respective geographic location or position. In such examples, the network may selectively apply different values, characteristics, or parameters of a PCC rule, or different PCC rules, depending on a (known, estimated, or predicted) location of the UE.

FIG. 4 shows an example of a process flow 400 that supports network coverage-based QoS scheduling in accordance with one or more aspects of the present disclosure. The process flow 400 may implement or be implemented to realize one or more aspects of the wireless communications system 100, the network coverage timeline 200, or the network diagram 300. For example, the process flow 400 illustrates communication between network devices, entities, or functionalities including an AF 305, a PCF 320, an SMF 330, and a UPF 340, which may be examples of corresponding devices as illustrated and described herein, including by and with reference to FIG. 3. Each of the AF 305, the PCF 320, the SMF 330, and the UPF 340 may be an example of, located at, associated with, included in, or otherwise understood as a (respective) core network entity.

In the following description of the process flow 400, the operations may be performed (such as reported or provided) in a different order than the order shown, or the operations performed by the example network devices, entities, or functionalities may be performed in different orders or at different times. Some operations also may be left out of the process flow 400, or other operations may be added to the process flow 400. Further, although some operations or signaling may be shown to occur at different times for discussion purposes, these operations may actually occur at the same time.

At 405, the AF 305 (or, more generally, any first network device, entity, or functionality) may obtain a network coverage prediction associated with an upcoming time window (e.g., the time window 225). For example, the AF 305 may receive information indicative of a sequence of communication metrics associated with a data flow, where each communication metric corresponds to a respective time segment within the upcoming time window. In some implementations, the AF 305 may receive the information indicative of the sequence of communication metrics (e.g., the network coverage prediction) in accordance with transmitting a request associated with the network coverage prediction. The AF 305 may receive the information indicative of the sequence of communication metrics from an NWDAF, a cloud device, or a server device. For example, the AF 305 may retrieve the predicted coverage, radio conditions, scheduling, data rate, or predicted QoS, among other examples, from the NWDAF, the cloud device, or the server device.

The sequence of communication metrics may include a first communication metric associated with a first time segment within the time window and a second communication metric associated with a second time segment within the time window. The sequence of communication metrics may include a sequence of QoS values, RSRPs, SINRs, CQIs, MCSs, spectral efficiencies, or data rates associated with the data flow. The sequence of communication metrics may include one or more predicted communication metrics, such as communication metrics that the AF 305, the NWDAF, the cloud device, or the server device predicts for a UE 115 in accordance with a (known or predicted) movement or route of the UE 115.

At 410, the AF 305 may determine whether one or more of the (predicted) communication metrics are below a threshold. For example, the AF 305 may determine whether at least one communication metric of the sequence of communication metrics fails to satisfy a threshold. At least one communication metric failing to satisfy a threshold may include a QoS failing to satisfy a threshold QoS, an SINR failing to satisfy a threshold SINR, a spectral efficiency failing to satisfy a threshold spectral efficiency, or a data rate failing to satisfy a threshold data rate, among other examples. In some implementations, the AF 305 may additionally determine whether at least one other communication metric of the sequence of communication metrics satisfies a threshold. At least one communication metric satisfying a threshold may include a QoS satisfying a threshold QoS, an SINR satisfying a threshold SINR, a spectral efficiency satisfying a threshold spectral efficiency, or a data rate satisfying a threshold data rate, among other examples.

In accordance with at least one communication metric failing to satisfy a threshold or at least one communication metric satisfying a threshold, or both, the AF 305 may determine to activate, trigger, or employ prediction-based QoS scheduling. For example, if a first communication metric (e.g., a first data rate) corresponding to a relatively earlier time segment within the time window satisfies a threshold and a second communication metric (e.g., a second data rate) corresponding to a relatively later time segment within the time window fails to satisfy the threshold, the AF 305 may determine to activate, trigger, or employ prediction-based QoS scheduling (such as to pre-download or otherwise overweight a data transfer within the relatively earlier time segment to compensate for coverage interruptions or low data rates within the relatively later time segment).

At 415, and in examples in which the AF 305 determines to activate, trigger, or employ prediction-based QoS scheduling, the AF 305 may generate a QoS schedule associated with the data flow and may transmit information indicative of the QoS schedule to the PCF 320 (or, more generally, any second network device, entity, or functionality). The QoS schedule may include or indicate a sequence of QoS values (e.g., a time domain series of QoS values), each QoS value of the sequence of QoS values corresponding to a respective time segment within the time window. For example, the sequence of QoS values may include a first QoS value that corresponds to the first time segment within the time window, a second QoS value that corresponds to a second time segment within the time window, and so on. In some aspects, the first QoS value may be based on or otherwise associated with the first communication metric associated with the first time segment and the second QoS value may be based on or otherwise associated with the second communication metric associated with the second time segment.

At 420, the PCF 320 may provision (e.g., create, generate, select, or otherwise determine) at least one PCC rule in accordance with the sequence of QoS values. The at least one PCC rule may include a single PCC rule or multiple PCC rules, as described in more detail herein, including with reference to FIG. 3. In examples in which the at least one PCC rule includes multiple PCC rules, each PCC rule may correspond to a respective time segment within the time window. For example, the multiple PCC rules may include a first PCC rule that corresponds to the first time segment within the time window, a second PCC rule that corresponds to the second time segment within the time window, and so on. In some aspects, the first PCC rule may be based on or otherwise associated with the first QoS value corresponding to the first time segment and the second PCC rule may be based on or otherwise associated with the second QoS value corresponding to the second time segment.

In examples in which the at least one PCC rule includes a single PCC rule, the single PCC rule may be associated with a sequence of (e.g., a time series of or otherwise piecewise defined) values, parameters, or characteristics in accordance with the sequence of QoS values, each value/parameter/characteristic corresponding to a respective time segment within the time window. For example, the single PCC rule may include, indicate, or define a sequence of bitrate values, a sequence of QoS indicator values, a sequence of priority level values, or any combination thereof. A first value/parameter/characteristic (e.g., a first bitrate value, a first QoS indicator value, or a first priority level value) of the single PCC rule may correspond to the first time segment within the time window and a second value/parameter/characteristic (e.g., a second bitrate value, a second QoS indicator value, or a second priority level value) of the single PCC rule may correspond to the second time segment within the time window. In some aspects, the first value/parameter/characteristic may be based on or otherwise associated with the first QoS value corresponding to the first time segment and the second value/parameter/characteristic may be based on or otherwise associated with the second QoS value corresponding to the second time segment.

At 425, the PCF 320 may transmit information indicative of the at least one PCC rule to the SMF 330 (or, more generally, any third network device, entity, or functionality). The PCF 320 may transmit the information indicative of the at least one PCC rule as information indicative of a single rule for the entire time window or as multiple PCC rules (e.g., multiple updated PCC rules or PCC rule updates), each for a respective time segment within the time window. In examples in which the PCF 320 transmits information indicative of multiple PCC rules, the PCF 320 may transmit information indicative of each PCC rule at or prior to a beginning of a time segment within the time window to which that PCC rule applies. For example, the PCF 320 may transmit information indicative of the multiple PCC rules via a single message or via multiple messages at or prior to the time window. Additionally, or alternatively, the PCF 320 may sequentially transmit a set of messages within the time window, with each message indicating a respective PCC rule applicable to an upcoming (e.g., a next) time segment within the time window.

At 430, the SMF 330 may transmit information to the UPF 340 (or, more generally, any fourth network device, entity, or functionality) associated with the at least one PCC rule. For example, the SMF 330 may provide the UPF 340 with instructions according to which the UPF 340 is to enforce the at least one PCC rule (e.g., to enforce at least one authorized QoS associated with the at least one PCC rule). The authorized QoS enforced by the UPF 340 may change over time (e.g., between time segments within the time window) in accordance with the at least one PCC rule and, likewise, in accordance with the sequence of QoS values provided by the AF 305. Thus, the AF 305 may (indirectly or directly) provide information (e.g., predicted information such as predicted coverage, radio conditions, scheduling, data rate, or predicted QoS) to the PCF 320, the SMF 330, or the RAN 345 to configure estimated radio resources and QoS targets, constraints, or expectations.

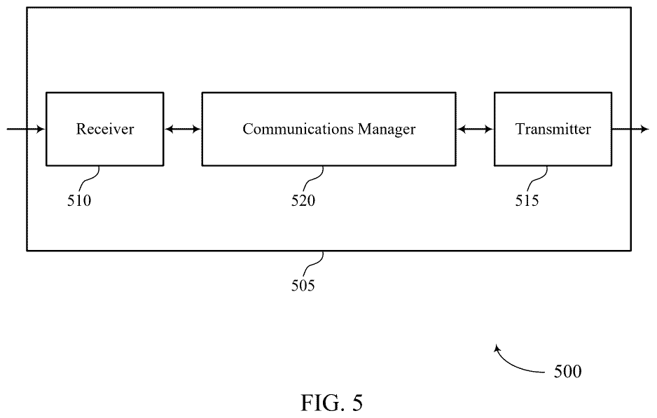

FIG. 5 shows a block diagram 500 of a device 505 that supports network coverage-based QoS scheduling in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of network coverage-based QoS scheduling as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for receiving first information indicative of a sequence of QoS values associated with a data flow, where the sequence of QoS values includes a first QoS value that corresponds to a first time segment within a time window and a second QoS value that corresponds to a second time segment within the time window. The communications manager 520 is capable of, configured to, or operable to support a means for transmitting second information indicative of at least one PCC rule associated with the data flow, where the at least one PCC rule is in accordance with the sequence of QoS values associated with the data flow.

Additionally, or alternatively, the communications manager 520 may support wireless communication in accordance with examples as disclosed herein. For example, the communications manager 520 is capable of, configured to, or operable to support a means for receiving first information indicative of a sequence of communication metrics associated with a data flow, where the sequence of communication metrics includes a first communication metric associated with a first time segment within a time window and a second communication metric associated with a second time segment within the time window. The communications manager 520 is capable of, configured to, or operable to support a means for transmitting second information indicative of a sequence of QoS values associated with the data flow, where the sequence of QoS values includes a first QoS value that corresponds to the first time segment within the time window and a second QoS value that corresponds to the second time segment within the time window.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources, among other benefits.

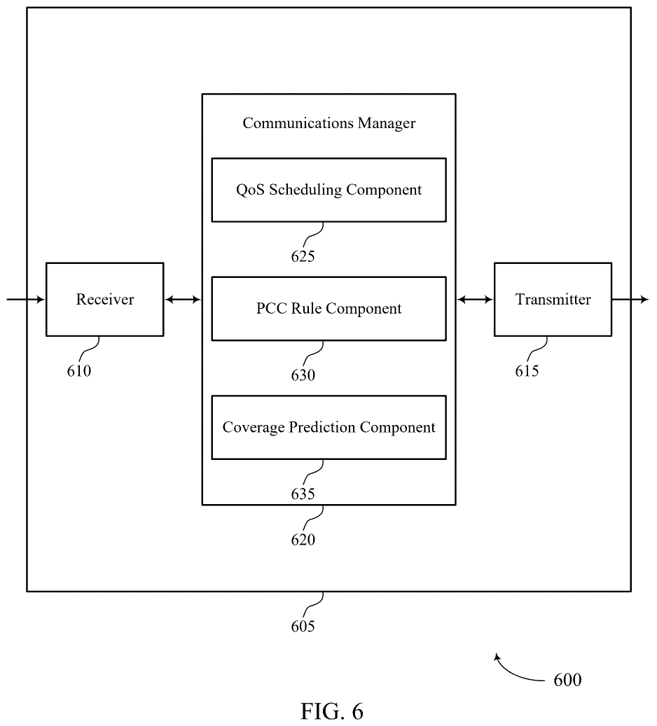

FIG. 6 shows a block diagram 600 of a device 605 that supports network coverage-based QoS scheduling in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of network coverage-based QoS scheduling as described herein. For example, the communications manager 620 may include a QoS scheduling component 625, a PCC rule component 630, a coverage prediction component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The QoS scheduling component 625 is capable of, configured to, or operable to support a means for receiving first information indicative of a sequence of QoS values associated with a data flow, where the sequence of QoS values includes a first QoS value that corresponds to a first time segment within a time window and a second QoS value that corresponds to a second time segment within the time window. The PCC rule component 630 is capable of, configured to, or operable to support a means for transmitting second information indicative of at least one PCC rule associated with the data flow, where the at least one PCC rule is in accordance with the sequence of QoS values associated with the data flow.

Additionally, or alternatively, the communications manager 620 may support wireless communication in accordance with examples as disclosed herein. The coverage prediction component 635 is capable of, configured to, or operable to support a means for receiving first information indicative of a sequence of communication metrics associated with a data flow, where the sequence of communication metrics includes a first communication metric associated with a first time segment within a time window and a second communication metric associated with a second time segment within the time window. The QoS scheduling component 625 is capable of, configured to, or operable to support a means for transmitting second information indicative of a sequence of QoS values associated with the data flow, where the sequence of QoS values includes a first QoS value that corresponds to the first time segment within the time window and a second QoS value that corresponds to the second time segment within the time window.

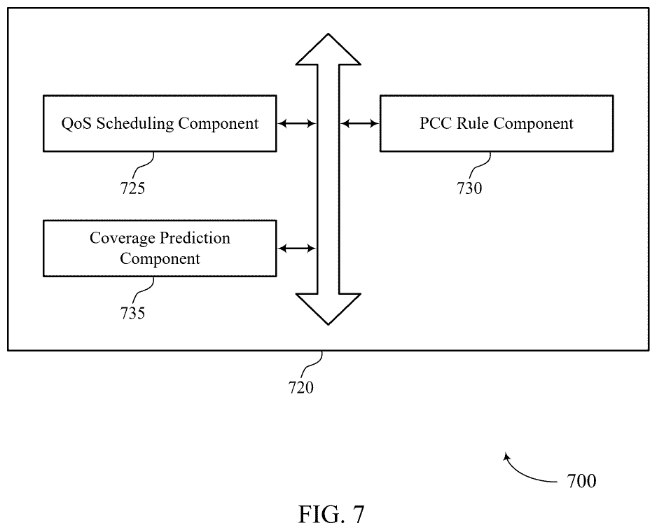

FIG. 7 shows a block diagram 700 of a communications manager 720 that supports network coverage-based QoS scheduling in accordance with one or more aspects of the present disclosure. The communications manager 720 may be an example of aspects of a communications manager 520, a communications manager 620, or both, as described herein. The communications manager 720, or various components thereof, may be an example of means for performing various aspects of network coverage-based QoS scheduling as described herein. For example, the communications manager 720 may include a QoS scheduling component 725, a PCC rule component 730, a coverage prediction component 735, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communication in accordance with examples as disclosed herein. The QoS scheduling component 725 is capable of, configured to, or operable to support a means for receiving first information indicative of a sequence of QoS values associated with a data flow, where the sequence of QoS values includes a first QoS value that corresponds to a first time segment within a time window and a second QoS value that corresponds to a second time segment within the time window. The PCC rule component 730 is capable of, configured to, or operable to support a means for transmitting second information indicative of at least one PCC rule associated with the data flow, where the at least one PCC rule is in accordance with the sequence of QoS values associated with the data flow.

In some examples, the PCC rule component 730 is capable of, configured to, or operable to support a means for provisioning the at least one PCC rule in accordance with the sequence of QoS values associated with the data flow, where transmitting the second information is in association with provisioning the at least one PCC rule.

In some examples, the at least one PCC rule includes a single PCC rule. In some examples, the single PCC rule includes a single QoS indicator value associated with the data flow and a sequence of bitrate values associated with the data flow. In some examples, the sequence of bitrate values including a first bitrate value corresponding to the first time segment within the time window and a second bitrate value corresponding to the second time segment within the time window. In some examples, the first bitrate value is associated with the first QoS value and the second bitrate value is associated with the second QoS value.

In some examples, the at least one PCC rule includes a single PCC rule. In some examples, the single PCC rule includes a sequence of QoS indicator values associated with the data flow, the sequence of QoS indicator values including a first QoS indicator value corresponding to the first time segment within the time window and a second QoS indicator value corresponding to the second time segment within the time window. In some examples, the first QoS indicator value is associated with the first QoS value and the second QoS indicator value is associated with the second QoS value.

In some examples, the at least one PCC rule includes a single PCC rule. In some examples, the single PCC rule includes a sequence of priority level values associated with the data flow, the sequence of priority level values including a first priority level value corresponding to the first time segment within the time window and a second priority level value corresponding to the second time segment within the time window. In some examples, the first priority level value is associated with the first QoS value and the second priority level value is associated with the second QoS value.

In some examples, the at least one PCC rule includes a sequence of PCC rules. In some examples, the sequence of PCC rules includes a first PCC rule corresponding to the first time segment within the time window and a second PCC rule corresponding to the second time segment within the time window. In some examples, the first PCC rule is associated with the first QoS value and the second PCC rule is associated with the second QoS value.

In some examples, to support transmitting the second information indicative of the at least one PCC rule, the PCC rule component 730 is capable of, configured to, or operable to support a means for transmitting an indication of the first PCC rule at or prior to a beginning of the first time segment within the time window. In some examples, to support transmitting the second information indicative of the at least one PCC rule, the PCC rule component 730 is capable of, configured to, or operable to support a means for transmitting an indication of the second PCC rule at or prior to a beginning of the second time segment within the time window.

In some examples, the core network entity receives the first information indicative of the sequence of QoS values in association with at least a first communication metric associated with the data flow within the time window failing to satisfy a threshold, at least a second communication metric associated with the data flow within the time window satisfying the threshold, or both. In some examples, the first communication metric and the second communication metric are predicted quality of services, predicted SINRs, predicted spectral efficiencies, or predicted data rates associated with the data flow.

In some examples, the core network entity includes a policy control function. In some examples, the policy control function receives the first information from an application function and transmits the second information to a session management function. In some examples, the time window includes a set of multiple time segments. In some examples, the set of multiple time segments are of equal or different durations.

Additionally, or alternatively, the communications manager 720 may support wireless communication in accordance with examples as disclosed herein. The coverage prediction component 735 is capable of, configured to, or operable to support a means for receiving first information indicative of a sequence of communication metrics associated with a data flow, where the sequence of communication metrics includes a first communication metric associated with a first time segment within a time window and a second communication metric associated with a second time segment within the time window. In some examples, the QoS scheduling component 725 is capable of, configured to, or operable to support a means for transmitting second information indicative of a sequence of QoS values associated with the data flow, where the sequence of QoS values includes a first QoS value that corresponds to the first time segment within the time window and a second QoS value that corresponds to the second time segment within the time window.

In some examples, the coverage prediction component 735 is capable of, configured to, or operable to support a means for transmitting a request associated with a network coverage prediction within the time window, where receiving the first information indicative of the sequence of communication metrics is in association with transmitting the request.

In some examples, transmitting the second information indicative of the sequence of QoS values is in association with at least one communication metric of the sequence of communication metrics failing to satisfy a threshold. In some examples, transmitting the second information indicative of the sequence of QoS values is in association with at least one communication metric of the sequence of communication metrics failing to satisfy a threshold and at least one other communication metric of the sequence of communication metrics satisfying the threshold.

In some examples, the sequence of communication metrics includes a sequence of predicted communication metrics associated with the data flow. In some examples, the sequence of communication metrics includes a sequence of predicted quality of services, predicted SINRs, predicted spectral efficiencies, or predicted data rates associated with the data flow.

In some examples, the core network entity includes an application function. In some examples, the application function receives the first information from an NWDAF, a cloud device, or a server device. In some examples, the application function transmits the second information to a policy control function. In some examples, the time window includes a set of multiple time segments. In some examples, the set of multiple time segments are of equal or different durations.

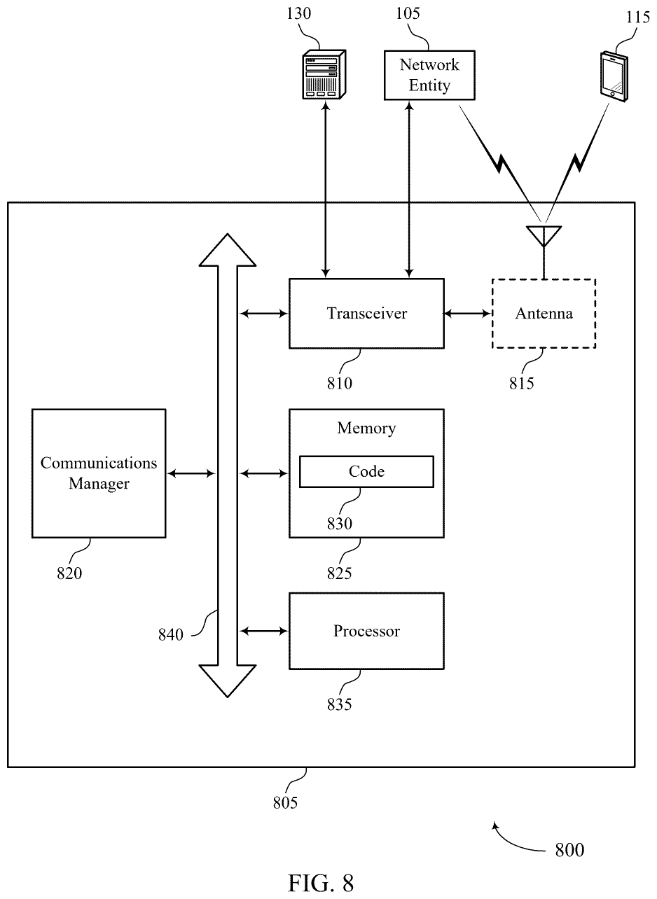

FIG. 8 shows a diagram of a system 800 including a device 805 that supports network coverage-based QoS scheduling in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting network coverage-based QoS scheduling). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communication in accordance with examples as disclosed herein. For example, the communications manager 820 is capable of, configured to, or operable to support a means for receiving first information indicative of a sequence of QoS values associated with a data flow, where the sequence of QoS values includes a first QoS value that corresponds to a first time segment within a time window and a second QoS value that corresponds to a second time segment within the time window. The communications manager 820 is capable of, configured to, or operable to support a means for transmitting second information indicative of at least one PCC rule associated with the data flow, where the at least one PCC rule is in accordance with the sequence of QoS values associated with the data flow.

Additionally, or alternatively, the communications manager 820 may support wireless communication in accordance with examples as disclosed herein. For example, the communications manager 820 is capable of, configured to, or operable to support a means for receiving first information indicative of a sequence of communication metrics associated with a data flow, where the sequence of communication metrics includes a first communication metric associated with a first time segment within a time window and a second communication metric associated with a second time segment within the time window. The communications manager 820 is capable of, configured to, or operable to support a means for transmitting second information indicative of a sequence of QoS values associated with the data flow, where the sequence of QoS values includes a first QoS value that corresponds to the first time segment within the time window and a second QoS value that corresponds to the second time segment within the time window.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability, among other benefits.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of network coverage-based QoS scheduling as described herein, or the at least one processor 835 and the at least one memory 825 may be otherwise configured to, individually or collectively, perform or support such operations.

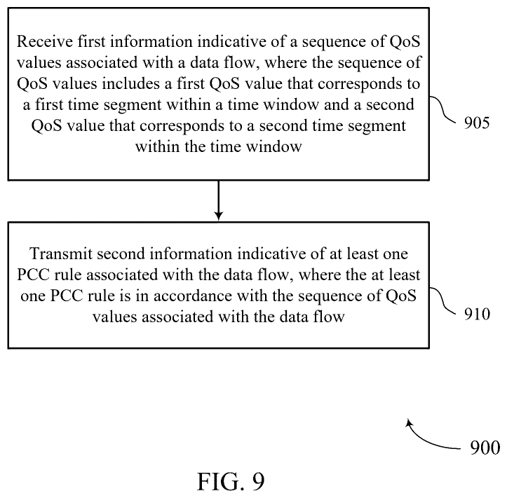

FIG. 9 shows a flowchart illustrating a method 900 that supports network coverage-based QoS scheduling in accordance with one or more aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include receiving first information indicative of a sequence of QoS values associated with a data flow, where the sequence of QoS values includes a first QoS value that corresponds to a first time segment within a time window and a second QoS value that corresponds to a second time segment within the time window. The operations of 905 may be performed in accordance with examples as disclosed herein, such as the reception of the QoS schedule at 415 of FIG. 4. Further, the sequence of QoS values may be the sequence of QoS values 350 associated with the data flow 315 of FIG. 3, with the sequence of QoS values 350 including a first QoS value 350-a that corresponds to a first time segment 355-a within a time window 225 and a second QoS value 350-b that corresponds to a second time segment 355-b within the time window 225. In some examples, aspects of the operations of 905 may be performed by a QoS scheduling component 725 as described with reference to FIG. 7.

At 910, the method may include transmitting second information indicative of at least one PCC rule associated with the data flow, where the at least one PCC rule is in accordance with the sequence of QoS values associated with the data flow. The operations of 910 may be performed in accordance with examples as disclosed herein, such as the transmission of the PCC rule(s) at 425 of FIG. 4. The at least one PCC rule may be the at least one PCC rule 360 associated with the data flow 315 of FIG. 3. In some examples, aspects of the operations of 910 may be performed by a PCC rule component 730 as described with reference to FIG. 7.

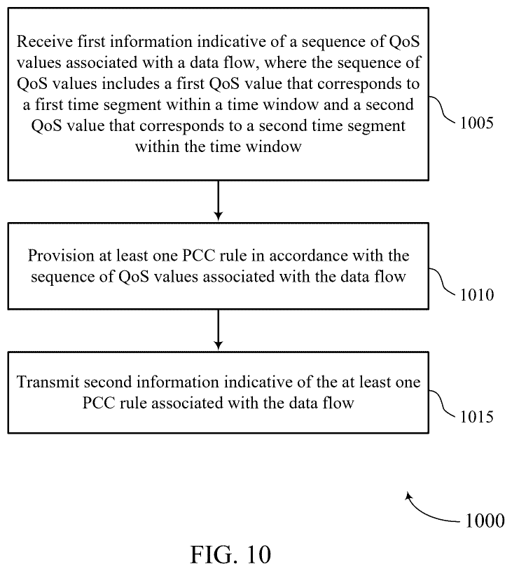

FIG. 10 shows a flowchart illustrating a method 1000 that supports network coverage-based QoS scheduling in accordance with one or more aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include receiving first information indicative of a sequence of QoS values associated with a data flow, where the sequence of QoS values includes a first QoS value that corresponds to a first time segment within a time window and a second QoS value that corresponds to a second time segment within the time window. The operations of 1005 may be performed in accordance with examples as disclosed herein, such as the reception of the QoS schedule at 415 of FIG. 4. Further, the sequence of QoS values may be the sequence of QoS values 350 associated with the data flow 315 of FIG. 3, with the sequence of QoS values 350 including a first QoS value 350-a that corresponds to a first time segment 355-a within a time window 225 and a second QoS value 350-b that corresponds to a second time segment 355-b within the time window 225. In some examples, aspects of the operations of 1005 may be performed by a QoS scheduling component 725 as described with reference to FIG. 7.

At 1010, the method may include provisioning at least one PCC rule in accordance with the sequence of QoS values associated with the data flow. The operations of 1010 may be performed in accordance with examples as disclosed herein, such as the provisioning of the at least one PCC rule at 420 of FIG. 4. The at least one PCC rule may be the at least one PCC rule 360 associated with the data flow 315 of FIG. 3. In some examples, aspects of the operations of 1010 may be performed by a PCC rule component 730 as described with reference to FIG. 7.

At 1015, the method may include transmitting second information indicative of the at least one PCC rule associated with the data flow. In some examples, the at least one PCC rule is in accordance with the sequence of QoS values associated with the data flow. The operations of 1015 may be performed in accordance with examples as disclosed herein, such as the transmission of the PCC rule(s) at 425 of FIG. 4. The at least one PCC rule may be the at least one PCC rule 360 associated with the data flow 315 of FIG. 3. In some examples, aspects of the operations of 1015 may be performed by a PCC rule component 730 as described with reference to FIG. 7.

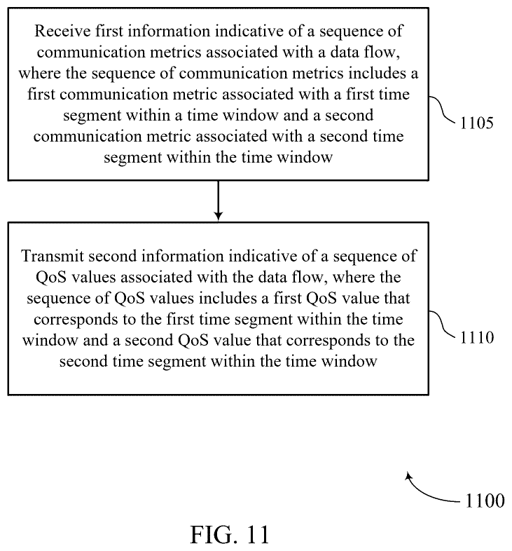

FIG. 11 shows a flowchart illustrating a method 1100 that supports network coverage-based QoS scheduling in accordance with one or more aspects of the present disclosure. The operations of the method 1100 may be implemented by a network entity or its components as described herein. For example, the operations of the method 1100 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1105, the method may include receiving first information indicative of a sequence of communication metrics associated with a data flow, where the sequence of communication metrics includes a first communication metric associated with a first time segment within a time window and a second communication metric associated with a second time segment within the time window. The operations of 1105 may be performed in accordance with examples as disclosed herein, such as obtainment of the network coverage prediction at 405 of FIG. 4. The data flow may be the data flow 315 of FIG. 3 and the time window may be the time window 225 of FIGS. 2 and 3. In some examples, aspects of the operations of 1105 may be performed by a coverage prediction component 735 as described with reference to FIG. 7.

At 1110, the method may include transmitting second information indicative of a sequence of QoS values associated with the data flow, where the sequence of QoS values includes a first QoS value that corresponds to the first time segment within the time window and a second QoS value that corresponds to the second time segment within the time window. The operations of 1110 may be performed in accordance with examples as disclosed herein, such as the transmission of the QoS schedule at 415 of FIG. 4. Further, the sequence of QoS values may be the sequence of QoS values 350 associated with the data flow 315 of FIG. 3, with the sequence of QoS values 350 including a first QoS value 350-a that corresponds to a first time segment 355-a within a time window 225 and a second QoS value 350-b that corresponds to a second time segment 355-b within the time window 225. In some examples, aspects of the operations of 1110 may be performed by a QoS scheduling component 725 as described with reference to FIG. 7.

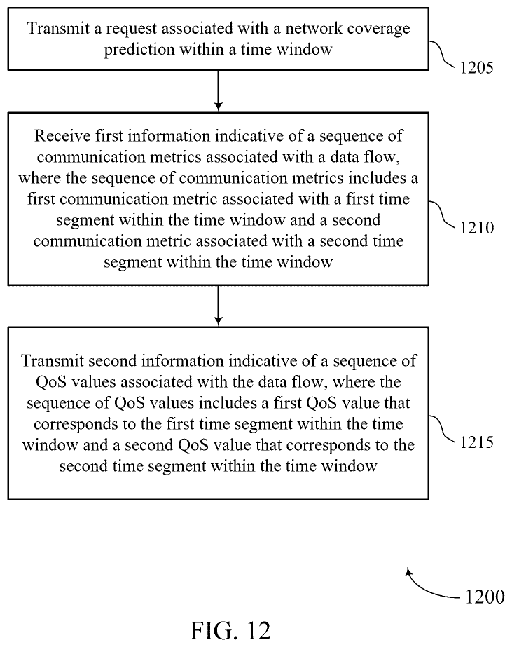

FIG. 12 shows a flowchart illustrating a method 1200 that supports network coverage-based QoS scheduling in accordance with one or more aspects of the present disclosure. The operations of the method 1200 may be implemented by a network entity or its components as described herein. For example, the operations of the method 1200 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1205, the method may include transmitting a request associated with a network coverage prediction within a time window. The operations of 1205 may be performed in accordance with examples as disclosed herein, such as in accordance with the AF 305 of FIGS. 3 and 4 requesting a network coverage prediction (e.g., predicted communication metrics) from one or more of an NWDAF, a cloud device, or a server device, among other examples. In some examples, aspects of the operations of 1205 may be performed by a coverage prediction component 735 as described with reference to FIG. 7.

At 1210, the method may include receiving first information indicative of a sequence of communication metrics associated with a data flow, where the sequence of communication metrics includes a first communication metric associated with a first time segment within the time window and a second communication metric associated with a second time segment within the time window. The operations of 1210 may be performed in accordance with examples as disclosed herein, such as obtainment of the network coverage prediction at 405 of FIG. 4. The data flow may be the data flow 315 of FIG. 3 and the time window may be the time window 225 of FIGS. 2 and 3. In some examples, aspects of the operations of 1210 may be performed by a coverage prediction component 735 as described with reference to FIG. 7.

At 1215, the method may include transmitting second information indicative of a sequence of QoS values associated with the data flow, where the sequence of QoS values includes a first QoS value that corresponds to the first time segment within the time window and a second QoS value that corresponds to the second time segment within the time window. The operations of 1215 may be performed in accordance with examples as disclosed herein, such as the transmission of the QoS schedule at 415 of FIG. 4. Further, the sequence of QoS values may be the sequence of QoS values 350 associated with the data flow 315 of FIG. 3, with the sequence of QoS values 350 including a first QoS value 350-a that corresponds to a first time segment 355-a within a time window 225 and a second QoS value 350-b that corresponds to a second time segment 355-b within the time window 225. In some examples, aspects of the operations of 1215 may be performed by a QoS scheduling component 725 as described with reference to FIG. 7.

The following provides an overview of aspects of the present disclosure:

Aspect 1: A method for wireless communication at a core network entity, comprising: receiving first information indicative of a sequence of QoS values associated with a data flow, wherein the sequence of QoS values comprises a first QoS value that corresponds to a first time segment within a time window and a second QoS value that corresponds to a second time segment within the time window; and transmitting second information indicative of at least one PCC rule associated with the data flow, wherein the at least one PCC rule is in accordance with the sequence of QoS values associated with the data flow.

Aspect 2: The method of aspect 1, further comprising: provisioning the at least one PCC rule in accordance with the sequence of QoS values associated with the data flow, wherein transmitting the second information is in association with provisioning the at least one PCC rule.

Aspect 3: The method of any of aspects 1-2, wherein the at least one PCC rule comprises a single PCC rule, and the single PCC rule comprises a single QoS indicator value associated with the data flow; and a sequence of bitrate values associated with the data flow, the sequence of bitrate values comprising a first bitrate value corresponding to the first time segment within the time window and a second bitrate value corresponding to the second time segment within the time window.

Aspect 4: The method of aspect 3, wherein the first bitrate value is associated with the first QoS value and the second bitrate value is associated with the second QoS value.

Aspect 5: The method of any of aspects 1-2, wherein the at least one PCC rule comprises a single PCC rule, and the single PCC rule comprises a sequence of QoS indicator values associated with the data flow, the sequence of QoS indicator values comprising a first QoS indicator value corresponding to the first time segment within the time window and a second QoS indicator value corresponding to the second time segment within the time window.

Aspect 6: The method of aspect 5, wherein the first QoS indicator value is associated with the first QoS value and the second QoS indicator value is associated with the second QoS value.

Aspect 7: The method of any of aspects 1-6, wherein the at least one PCC rule comprises a single PCC rule, and the single PCC rule comprises a sequence of priority level values associated with the data flow, the sequence of priority level values comprising a first priority level value corresponding to the first time segment within the time window and a second priority level value corresponding to the second time segment within the time window.

Aspect 8: The method of aspect 7, wherein the first priority level value is associated with the first QoS value and the second priority level value is associated with the second QoS value.

Aspect 9: The method of any of aspects 1-2, wherein the at least one PCC rule comprises a sequence of PCC rules, and the sequence of PCC rules comprises a first PCC rule corresponding to the first time segment within the time window and a second PCC rule corresponding to the second time segment within the time window.

Aspect 10: The method of aspect 9, wherein the first PCC rule is associated with the first QoS value and the second PCC rule is associated with the second QoS value.

Aspect 11: The method of any of aspects 9-10, wherein transmitting the second information indicative of the at least one PCC rule comprises: transmitting an indication of the first PCC rule at or prior to a beginning of the first time segment within the time window; and transmitting an indication of the second PCC rule at or prior to a beginning of the second time segment within the time window.

Aspect 12: The method of any of aspects 1-11, wherein the core network entity receives the first information indicative of the sequence of QoS values in association with at least a first communication metric associated with the data flow within the time window failing to satisfy a threshold, at least a second communication metric associated with the data flow within the time window satisfying the threshold, or both.

Aspect 13: The method of aspect 12, wherein the first communication metric and the second communication metric are predicted QoSs, predicted SINRs, predicted spectral efficiencies, or predicted data rates associated with the data flow.

Aspect 14: The method of any of aspects 1-13, wherein the core network entity comprises a PCF, and the PCF receives the first information from an AF and transmits the second information to an SMF.

Aspect 15: The method of any of aspects 1-14, wherein the time window comprises a plurality of time segments, and the plurality of time segments are of equal or different durations.

Aspect 16: A method for wireless communication at a core network entity, comprising: receiving first information indicative of a sequence of communication metrics associated with a data flow, wherein the sequence of communication metrics comprises a first communication metric associated with a first time segment within a time window and a second communication metric associated with a second time segment within the time window; and transmitting second information indicative of a sequence of QoS values associated with the data flow, wherein the sequence of QoS values comprises a first QoS value that corresponds to the first time segment within the time window and a second QoS value that corresponds to the second time segment within the time window.

Aspect 17: The method of aspect 16, further comprising: transmitting a request associated with a network coverage prediction within the time window, wherein receiving the first information indicative of the sequence of communication metrics is in association with transmitting the request.

Aspect 18: The method of any of aspects 16-17, wherein transmitting the second information indicative of the sequence of QoS values is in association with at least one communication metric of the sequence of communication metrics failing to satisfy a threshold.

Aspect 19: The method of any of aspects 16-18, wherein transmitting the second information indicative of the sequence of QoS values is in association with at least one communication metric of the sequence of communication metrics failing to satisfy a threshold and at least one other communication metric of the sequence of communication metrics satisfying the threshold.

Aspect 20: The method of any of aspects 16-19, wherein the sequence of communication metrics comprises a sequence of predicted communication metrics associated with the data flow.

Aspect 21: The method of any of aspects 16-20, wherein the sequence of communication metrics comprises a sequence of predicted QoSs, predicted SINRs, predicted spectral efficiencies, or predicted data rates associated with the data flow.

Aspect 22: The method of any of aspects 16-21, wherein the core network entity comprises an AF, the AF receives the first information from an NWDAF, a cloud device, or a server device, and the AF transmits the second information to a PCF.

Aspect 23: The method of any of aspects 16-22, wherein the time window comprises a plurality of time segments, and the plurality of time segments are of equal or different durations.

Aspect 24: A core network entity for wireless communication, comprising one or more memories storing processor-executable code, and one or more processors coupled with the one or more memories and individually or collectively operable to execute the code to cause the core network entity to perform a method of any of aspects 1-15.

Aspect 25: A core network entity for wireless communication, comprising at least one means for performing a method of any of aspects 1-15.

Aspect 26: A non-transitory computer-readable medium storing code for wireless communication, the code comprising instructions executable by one or more processors to perform a method of any of aspects 1-15.

Aspect 27: A core network entity for wireless communication, comprising one or more memories storing processor-executable code, and one or more processors coupled with the one or more memories and individually or collectively operable to execute the code to cause the core network entity to perform a method of any of aspects 16-23.

Aspect 28: A core network entity for wireless communication, comprising at least one means for performing a method of any of aspects 16-23.

Aspect 29: A non-transitory computer-readable medium storing code for wireless communication, the code comprising instructions executable by one or more processors to perform a method of any of aspects 16-23.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A core network entity, comprising:
one or more memories storing processor-executable code; and
one or more processors coupled with the one or more memories and individually or collectively operable to execute the code to cause the core network entity to:
receive first information indicative of a sequence of quality of service values associated with a data flow, wherein the sequence of quality of service values comprises a first quality of service value that corresponds to a first time segment within a time window and a second quality of service value that corresponds to a second time segment within the time window; and
transmit second information indicative of at least one policy and charging control rule associated with the data flow, wherein the at least one policy and charging control rule is in accordance with the sequence of quality of service values associated with the data flow.

2. The core network entity of claim 1, wherein the one or more processors are individually or collectively further operable to execute the code to cause the core network entity to:
provision the at least one policy and charging control rule in accordance with the sequence of quality of service values associated with the data flow, wherein transmitting the second information is in association with provisioning the at least one policy and charging control rule.

3. The core network entity of claim 1, wherein the at least one policy and charging control rule comprises a single policy and charging control rule, and wherein the single policy and charging control rule comprises:
a single quality of service indicator value associated with the data flow; and
a sequence of bitrate values associated with the data flow, the sequence of bitrate values comprising a first bitrate value corresponding to the first time segment within the time window and a second bitrate value corresponding to the second time segment within the time window.

4. The core network entity of claim 3, wherein the first bitrate value is associated with the first quality of service value and the second bitrate value is associated with the second quality of service value.

5. The core network entity of claim 1, wherein the at least one policy and charging control rule comprises a single policy and charging control rule, and wherein the single policy and charging control rule comprises:
a sequence of quality of service indicator values associated with the data flow, the sequence of quality of service indicator values comprising a first quality of service indicator value corresponding to the first time segment within the time window and a second quality of service indicator value corresponding to the second time segment within the time window.

6. The core network entity of claim 5, wherein the first quality of service indicator value is associated with the first quality of service value and the second quality of service indicator value is associated with the second quality of service value.

7. The core network entity of claim 1, wherein the at least one policy and charging control rule comprises a single policy and charging control rule, and wherein the single policy and charging control rule comprises:
a sequence of priority level values associated with the data flow, the sequence of priority level values comprising a first priority level value corresponding to the first time segment within the time window and a second priority level value corresponding to the second time segment within the time window.

8. The core network entity of claim 7, wherein the first priority level value is associated with the first quality of service value and the second priority level value is associated with the second quality of service value.

9. The core network entity of claim 1, wherein the at least one policy and charging control rule comprises a sequence of policy and charging control rules, and wherein the sequence of policy and charging control rules comprises:
a first policy and charging control rule corresponding to the first time segment within the time window and a second policy and charging control rule corresponding to the second time segment within the time window.

10. The core network entity of claim 9, wherein the first policy and charging control rule is associated with the first quality of service value and the second policy and charging control rule is associated with the second quality of service value.

11. The core network entity of claim 9, wherein, to transmit the second information indicative of the at least one policy and charging control rule, the one or more processors are individually or collectively operable to execute the code to cause the core network entity to:
transmit an indication of the first policy and charging control rule at or prior to a beginning of the first time segment within the time window; and
transmit an indication of the second policy and charging control rule at or prior to a beginning of the second time segment within the time window.

12. The core network entity of claim 1, wherein the core network entity receives the first information indicative of the sequence of quality of service values in association with at least a first communication metric associated with the data flow within the time window failing to satisfy a threshold, at least a second communication metric associated with the data flow within the time window satisfying the threshold, or both.

13. The core network entity of claim 12, wherein the first communication metric and the second communication metric are predicted quality of services, predicted signal-to-interference-plus-noise ratios (SINRs), predicted spectral efficiencies, or predicted data rates associated with the data flow.

14. The core network entity of claim 1, wherein the core network entity comprises a policy control function, and wherein the policy control function receives the first information from an application function and transmits the second information to a session management function.

15. The core network entity of claim 1, wherein the time window comprises a plurality of time segments, and wherein the plurality of time segments are of equal or different durations.

16. A method for wireless communication at a core network entity, comprising:
receiving first information indicative of a sequence of quality of service values associated with a data flow, wherein the sequence of quality of service values comprises a first quality of service value that corresponds to a first time segment within a time window and a second quality of service value that corresponds to a second time segment within the time window; and
transmitting second information indicative of at least one policy and charging control rule associated with the data flow, wherein the at least one policy and charging control rule is in accordance with the sequence of quality of service values associated with the data flow.

17. The method of claim 16, further comprising:
provisioning the at least one policy and charging control rule in accordance with the sequence of quality of service values associated with the data flow, wherein transmitting the second information is in association with provisioning the at least one policy and charging control rule.

18. The method of claim 16, wherein the core network entity receives the first information indicative of the sequence of quality of service values in association with at least a first communication metric associated with the data flow within the time window failing to satisfy a threshold, at least a second communication metric associated with the data flow within the time window satisfying the threshold, or both.

19. The method of claim 16, wherein the core network entity comprises a policy control function, and wherein the policy control function receives the first information from an application function and transmits the second information to a session management function.

20. A core network entity for wireless communication, comprising:
means for receiving first information indicative of a sequence of quality of service values associated with a data flow, wherein the sequence of quality of service values comprises a first quality of service value that corresponds to a first time segment within a time window and a second quality of service value that corresponds to a second time segment within the time window; and
means for transmitting second information indicative of at least one policy and charging control rule associated with the data flow, wherein the at least one policy and charging control rule is in accordance with the sequence of quality of service values associated with the data flow.
